(19) United States
(12) Patent Application Publication
(10) Pub. No.: US 2012/0146906 A1
(43) Pub. Date: Jun. 14, 2012

(54) PROMOTABLE INTELLIGENT DISPLAY DEVICE AND PROMOTING METHOD THEREOF

(75) Inventor: Se Kyung Song, Seongnam-si (KR)

(73) Assignee: FUTURE ROBOT CO., LTD., Suwon-si, Gyeonggi-do (KR)

(21) Appl. No.: 13/390,003

(22) PCT Filed: Aug. 11, 2010
(86) PCT No.: PCT/KR2010/005261

§ 371 Date: Feb. 10, 2012

(30) Foreign Application Priority Data
Aug. 11, 2009 (KR) 10-2009-0073739

(51) Int. Cl. G06F 3/033

(52) U.S. Cl. 345/158

(57) ABSTRACT

A promotable intelligent display device includes: an image output means outputting character and promotion images; a camera taking pictures of people; an image recognition means receiving the taken image, and outputting contextual information source among information on position of people, moving direction, distance, number, and size; a controlling means specifying a promotion target at time intervals based on the contextual information, determining driving information on the direction and speed of rotation of the image output means based on the information on moving direction and position of the promotion target, and determining promotion activities by the distance, number, and size of the promotion target; a voice output means outputting promotion and character voices based on the promotion activities; and a driving means connected with the image output means by connection shaft to enable the rotation of the image output means by controlling a shaft based on the driving information and promotion activities.

### TECHNICAL FIELD

The present invention relates to a promotable intelligent display device and a promotion method thereof and, more particularly, to a promotable intelligent display device, which determines a promotion target on the basis of contextual information perceived through image recognition means 100 and uses image output means and driving means for promotion, and a promotion method thereof.

### BACKGROUND ART

In general, various kinds of display devices are used a lot for various kinds of promotion or the guidance of stores, firms, and public places. When viewing from this point of view, computer automation systems (i.e., kiosk), such as Automatic Teller Machine (ATM) terminals for financial business installed in public places for convenience of customers, terminals executing note issuing, purchase, and registration for customers, and terminals for information search for providing advertisement and information, are also on the same line. Furthermore, the most advance service robot can also play this role.

The display devices or the unmanned automated devices for public information, however, are disadvantageous in that they make people easily feel a repugnance to them because provided service is monotonous and repetitive. Furthermore, to give shape having a person's face to a service robot or to fabricate the hand and an arm having multiple degrees of freedom requires high development costs, and it is insufficient in expression. Furthermore, the body of a robot is disadvantageous in public information because it has a small monitor.

The existing display device for public information is disadvantageous in that it does not take the subjects of promotion or users into consideration because the existing display device is installed in a fixed place and in a predetermined direction and the existing display device plays information one-sidedly and provides simple and repetitive information.

Accordingly, there is a need for an intelligent display device which can provide customized information through user recognition, double an information acquisition effect by expressing an interest and a feeling of intimacy through voice, gestures and characters at the request of a user, and increase promotion and guidance effects.

### DISCLOSURE

### Technical Problem

Accordingly, the present invention has been made in view of the above need, and an object of the present invention is to provide a promotable intelligent display device and a promotion method thereof, which can determine a promotion target and a promotion behavior by using image recognition means in order to provide promotion or guidance information and increase promotion and guidance effects through an image, voice, characters, etc. at the request of a user.

Another object of the present invention is to provide a promotable intelligent display device including driving means along with image recognition means, which can induce a user to have a user-customized method or human-friendly sympathy by allowing the display device to properly handle the behavior of a promotion target, and a promotion method thereof.

### Technical Solution

The object of the present invention may be achieved by providing a promotable intelligent display device, comprising first image output means 300 for outputting a character image of a specific character and a promotion image for specific promotion; a camera 110 placed on one side of the first image output means 300, for capturing an image of one or more persons; image recognition means 100 for receiving the captured image of the camera 110 and outputting at least one piece of contextual information, from among position information, moving direction information, and distance information of the one or more persons, information about the number of persons, and large and small information of the one or more persons; control means 600 for specifying a promotion target at specific time intervals on the basis of the recognized contextual information of the image recognition means 100, determining driving information regarding a speed and direction of rotational movement or rotation of the first image output means 300 on the basis of position information and moving direction information about the specified promotion target, and determining a promotion behavior according to distance information of the promotion target, information about the number of persons, and large and small information of the promotion target; voice output means 400 for outputting character voice of the character and the promotion voice for promotion on the basis of the promotion behavior determined by the control means 600; and first driving means 500 connected to the first image output means 300 through a specific first connection shaft 502, for enabling the first image output means 300 to be rotatably moved or rotated through at least one-axis control on the basis of the determined driving information and the determined promotion behavior.

It is preferred that the promotion image be product information or store guidance information.

The camera 110 comprise two or more cameras 110 spaced apart from each other, and the image recognition means 100 may obtain the distance information as a relative position contrasted with a background image, of the same person who is photographed by the two or more cameras 110 at the same time.

Furthermore, it is preferred that the distance information be distance information from the first image output means 300 to the one or more persons.

It is preferred that the specified promotion target be a person having a least change in the position from among the one or more persons.

It is preferred that the promotion behavior include at least one of the promotion image, the promotion voice, a motion of the first image output means 300, and a change of the character image.

It is preferred that the first driving means 500 comprise one or more rotation motor units consecutively connected to an end of the first connection shaft 502, formed in the backside of the first image output means 300, in the length direction.

It is preferred that the first connection shaft 502 further comprise a bearing sphere 510 formed at the end of the length direction and the one or more rotation motor units be adjoined to the bearing sphere 510 and be rotated.

It is preferred the first driving means 500 comprise a motor coupling unit 520 further formed in the first connection shaft 502 and one or more linear driving motor units connected to the motor coupling unit 520.

It is preferred that the promotable intelligent display device further comprise microphones 210a and 210b for receiving sound information and voice recognition means 200 for recognizing voice of the one or more persons on the basis of the sound information received through the microphones 210a and 210b, wherein the control means 600 specifies the promotion target on the basis of voice information of the recognized voice along with the recognized contextual information.

It is preferred that the first driving means 500 be placed under the first image output means 300 and the promotable intelligent display device further comprise second image output means 350 under the first driving means 500 and second driving means 550 connected to the second connection shaft 552 formed in the backside of the second image output means 350, thus enabling the second image output means 350 to be rotated and rotatably moved.

It is preferred that the second image output means 350 be a touch screen for receiving a touch input of a specific user.

It is preferred that the promotable intelligent display device further comprise one or more proximity sensors 700 and 750 for preventing the first driving means and the second driving means from being driven by outputting a detection signal to the control means 600, if the promotion target or a specific object approaches the first image output means 300 and the second image output means 350 within a specific area.

Meanwhile, as another category, the object of the present invention may be achieved by providing a promotion method of an intelligent display device, comprising an image recognition step (S110) in which the image recognition means 100 receives an image captured by the camera 110 and recognizes at least one piece of contextual information, from among position information, moving direction information, and distance information of one or more persons, information about the number of persons, and large and small information of the one or more persons, from the received image; a first determination step (S120) in which the control means 600 specifies a promotion target at specific time intervals on the basis of the recognized contextual information; a second determination step (S130) in which the control means 600 determines driving information of the first image output means 300, such as a speed and direction of rotational movement or rotation, on the basis of position information and moving direction information about the promotion target; a third determination step (S140) in which the control means 600 determines a promotion behavior according to distance information of the promotion target, information about the number of persons, and large and small information about the promotion target; a step S150 in which first driving means 500 connected to the first image output means 300 through a specific first connection shaft 502 rotatably moves or rotates the first image output means 300 through at least one-axis control on the basis of the determined driving information and the determined promotion behavior; an image output step (S160) in which the first image output means 300 outputs a character image or a promotion image on the basis of the promotion behavior; and a voice output step (S170) in which the voice output means 400 outputs character voice or promotion voice on the basis of the promotion behavior.

Furthermore, the object of the present invention may be achieved by providing a promotion method of an intelligent display device, comprising

an image recognition step (S210) in which the image recognition means 100 receives an image captured by the camera 110 and recognizes at least one piece of contextual information, from among position information, moving direction information, and distance information of one or more persons, information about the number of persons, and large and small information of the one or more persons, from the received image; a voice recognition step (S215) in which the voice recognition means 200 recognizes voice of the one or more persons on the basis of sound received through the microphones 210a and 210b; a first determination step (S220) in which the control means 600 specifies a promotion target at specific time intervals on the basis of the recognized contextual information and voice information of the recognized voice; a second determination step (S230) in which the control means 600 determines driving information of the first image output means 300, such as speed of revolution and a rotation direction, on the basis of position information and moving direction information about the promotion target; a third determination step (S240) in which the control means 600 determines a promotion behavior according to distance information of the promotion target, information about the number of persons, and large and small information about the promotion target; a step S250 in which the first driving means 500 connected to the first image output means 300 through a specific first connection shaft 502 rotatably moves or rotates the first image output means 300 through at least one-axis control on the basis of the determined driving information and the determined promotion behavior; an image output step (S260) in which the first image output means 300 outputs a character image or a promotion image on the basis of the promotion behavior; and a voice output step (S270) in which the voice output means 400 outputs character voice or promotion voice on the basis of the promotion behavior.

### Advantageous Effects

In accordance with an embodiment of the present invention, there are advantages in that a promotion target and a promotion behavior can be determined by using the image recognition means in order to provide promotion or guidance information and promotion and guidance effects can be increased through an image, voice, characters, etc. at the request of a user.

Furthermore, there are advantages in that a user can be induced to have a user-customized method or human-friendly sympathy by allowing the display device to properly handle the behavior of a promotion target using the driving means along with the image recognition means.

### DESCRIPTION OF DRAWINGS

FIG. 1 is a construction simply showing the construction of an embodiment according to the present invention,

FIG. 2 is a front view showing the front of a promotable intelligent display device according to a first embodiment of the present invention and is an operating state diagram schematically showing the driving state of first driving means subject to 3-axis control,

FIG. 3 is a front view showing a first modification example of the first driving means subject to 3-axis control in an embodiment according to the present invention,

FIG. 4 is a front view showing a second modification example of the first driving means subject to 3-axis control in an embodiment according to the present invention,

FIG. 5 is a front view showing the front of a promotable intelligent display device according to a second embodiment of the present invention and is a partially enlarged view schematically showing first driving means and second driving means subject to 3-axis control,

FIG. 6 is a flowchart illustrating a first embodiment of a promotion method according to the present invention, and

FIG. 7 is a flowchart illustrating a second embodiment of a promotion method according to the present invention.

### DESCRIPTION OF REFERENCE NUMERALS OF PRINCIPAL ELEMENTS IN THE DRAWINGS

100: image recognition means

110: camera

200: voice recognition means

210a, 210b: microphones

300: first image output means

350: second image output means

400: voice output means

500: first driving means

502, 520, 530, 572: first connection shaft

510, 560, 580: bearing sphere

512a, 522a, 562a, 582a: first rotation motor unit

512b, 522b, 562b, 582b: second rotation motor unit

512c, 522c, 562c, 582c: third rotation motor unit

530: motor coupling unit

532a: first linear driving motor unit

532b: second linear driving motor unit

532c: third linear driving motor unit

550: second driving means

552: second connection shaft

600: control means

700, 750: proximity sensor

800: support means

### MODE FOR INVENTION

### First Embodiment of Intelligent Display Device

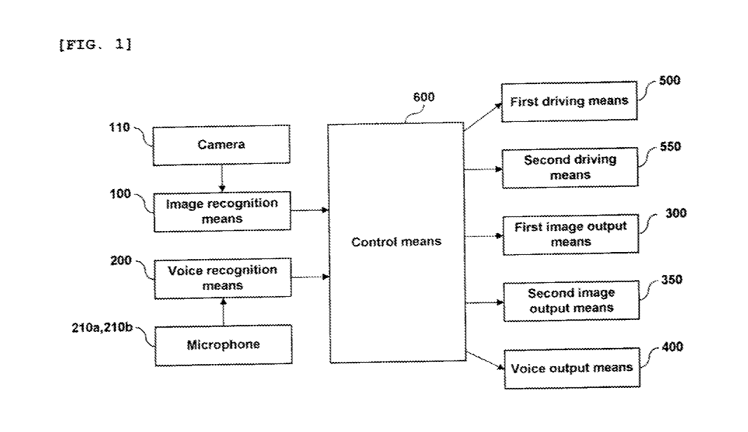

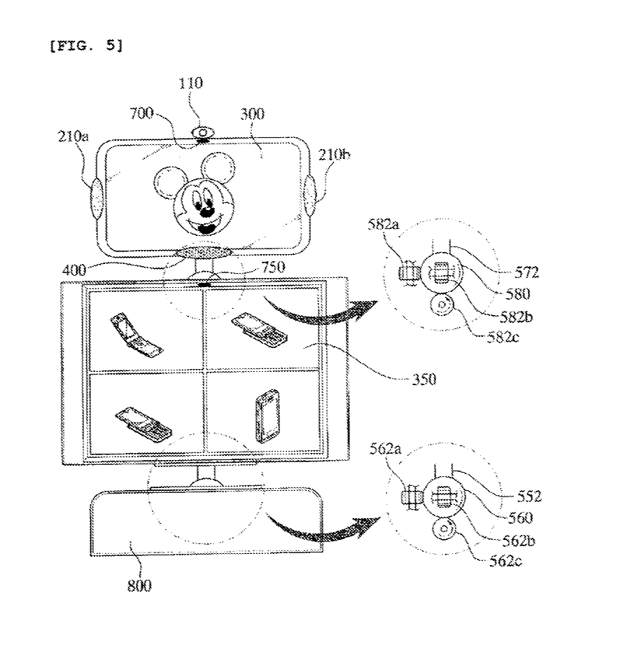

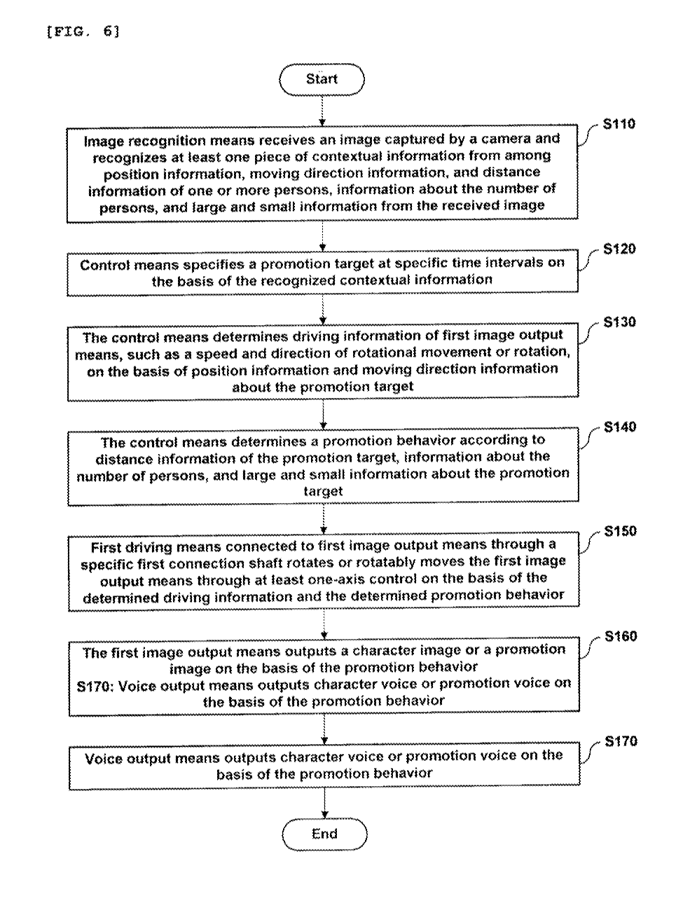

FIG. 1 is a construction simply showing the construction of an embodiment according to the present invention. As shown in FIG. 1, a first embodiment of a promotable intelligent display device according to the present invention includes a camera 110, image recognition means 100, first image output means 300, voice output means 400, first driving means 500, and control means 600 as basic elements. Microphones 210a and 210b and voice recognition means 200 may be added to the promotable intelligent display device. Furthermore, a second embodiment of the present invention to be described with reference to FIG. 5 is constructed by adding second image output means 350 and second driving means 550 to the first embodiment.

A connection and operation between the elements forming the present invention are described in short below with reference to FIG. 1.

When the first camera 110 captures an image of one or more persons and transmits the image to the image recognition means 100, the image recognition means 100 outputs contextual information to the control means 600 on the basis of the captured image. Furthermore, the control means 600 specifies a promotion target at specific time intervals on the basis of the contextual information, determines driving information of the first image output means 300, and determines a promotion behavior (e.g., image/voice output for product information or store guidance, image/voice output for a character, and various kinds of gestures) to be performed by the intelligent display device.

Furthermore, the control means 600 is connected to the first image output means 300, the voice output means 400, and the first driving means 500 and is configured to output a control command for a promotion behavior to the first image output means 300, the voice output means 400, and the first driving means 500. The first driving means 500 that has received the control command of the control means 600 rotatably moves or rotates and gives movement to the first image output means 300, and the first image output means 300 that has received the control command of the control means 600 outputs various kinds of character images or promotion images. Furthermore, the voice output means 400 that has received the control command of the control means 600 outputs character voice or promotion voice. Furthermore, the second image output means 350 and the second driving means 550 are also controlled in response to the control command for a promotion behavior which is received from the control means 600.

In addition, when the microphones 210a and 210b receive sound information including people's voice and transmit the sound information to the voice recognition means 200, the voice recognition means 200 analyzes the voice information. If the voice information includes specific voice information, the voice recognition means 200 outputs the voice information to the control means 600 so that the control means 600 uses the voice information, together with the contextual information, to specify a promotion target.

The construction shown in FIG. 1 is described in detail below.

The camera 110 is means for capturing an image by photographing one or more persons, and a digital camera having several hundreds of pixels may be used as the camera 110 in order to double an image recognition effect. The camera 110 is an essential element for extracting contextual information (e.g., position information, moving direction information, and distance information of one or more persons, information about the number of persons, and large and small information of the one or more persons) and is connected to the image recognition means 100.

The image recognition means 100 is means for obtaining and analyzing a captured image (e.g., a background image and one or more persons) and for obtaining desired contextual information from the analyzed image. To this end, the image recognition means 100 may basically include a processor for processing images and memory for storing images. Furthermore, the image recognition means 100 obtains contextual information by using algorithm means'suitable for an analysis purpose.

More specifically, in case of the position information of the persons, the image recognition means 100 may determine a two-dimensional position through a change of data of background image frames on the basis of the background image which is previously stored or periodically updated and stored. Furthermore, the image recognition means 100 may include the two or more cameras 110, synchronize the two or more cameras 110 with each other, and determine a three-dimensional position including distance information by comparing data of image frames obtained from the two or more cameras 110.

Furthermore, the moving direction information of the persons is determined from a change in the position through periodical image processing. Moving speed information of a person is determined like the moving direction information. In case of the information about the number of persons, schematic information about the number of persons is determined by classifying the number of persons by the step (e.g., two-step classification of singular number or plural number) rather than the accurate number of persons. Finally, the large and small information is for differentiating a promotion behavior by classifying adults or children. The large and small information is determined by extracting key information corresponding to a person's height by comparing the person's height with a background image with consideration taken of a change in the size of an image according to distance information.

The microphones 210a and 210b are means for obtaining sound information and transmitting the sound information to the voice recognition means 200. One microphone may be used, but two microphones spaced apart from each other preferably are used in order to determine a promotion target on the basis of the direction where sound is generated.

The voice recognition means 200 extracts voice information, corresponding to a person's voice, from the sound information received from the microphones 210a and 210b by using a noise cancellation filter (e.g., a Wiener filter or a Kalman filter). In particular, the voice information may be voice information outputted through the speaking of a user who uses the intelligent display device of the present invention. Here, the voice information may be a specific product name or a specific guidance term. In this case, the voice recognition means 200 also performs a function of searching for previously stored voice information by using a specific voice recognition algorithm.

The control means 600 outputs the control command on the basis of the contextual information analyzed by the image recognition means 100 and the voice information analyzed by the voice recognition means 200. If a promotion target is sought to be specified, a method of specifying a person who is closest to the first image output means 300 as a promotion target for a specific period of time on the basis of a person's distance information (i.e., distance information between the first image output means 300 and a person). If it is difficult to obtain distance information, a person who is placed in the direction where the voice analyzed by the voice recognition means 200 is generated as a promotion target.

Furthermore, the control means 600 determines driving information of the first image output means 300, such as speed of revolution and a rotation direction, on the basis of position information and moving direction information about a specific promotion target. The driving information of the first driving means 500 is calculated so that the first image output means 300 on which a character's face is displayed is directed toward the promotion target.

Furthermore, when a specific promotion target is placed within a specific distance, the control means 600 may consider the specified promotion target as a user of the embodiment of the present invention and determine a specific promotion behavior on the basis of the user. More specifically, the control means 600 makes a determination so that the first image output means outputs a change in the facial expression of a character or a gesture of the character, inducing a feeling of intimacy, in the form of an image. Furthermore, in case of product promotion, the control means 600 determines to output an image for the product information and to output product promotion voice through the voice output means 400. In case of guidance information output, the control means 600 determines to output guidance information about a store, a firm, or a public office in the form of an image and voice. Meanwhile, if a specific user uses a touch screen included in the second image output means 300, the control means 600 may determine to output a programmed process (e.g., a description of a product or guidance information) in response to a touch input signal. The first image output means 300 outputs a character image or a promotion image (e.g., product information, or store or firm guidance information) on the basis of the determination of the control means 600. A flat panel display device, such as an LCD, an LED, and a PDP, may be used as the first image output means 300. Furthermore, the character may make various facial expressions in response to the control command of the control means 600 (e.g., a smiling expression at the time of greeting voice output and a crying expression when a promotion target becomes distant).

The voice output means 400 outputs the product information or the store (or firm) guidance information in the form of voice. Furthermore, the voice output means 400 outputs voice (e.g., greeting voice or voice for touting) according to the various facial expressions of the character.

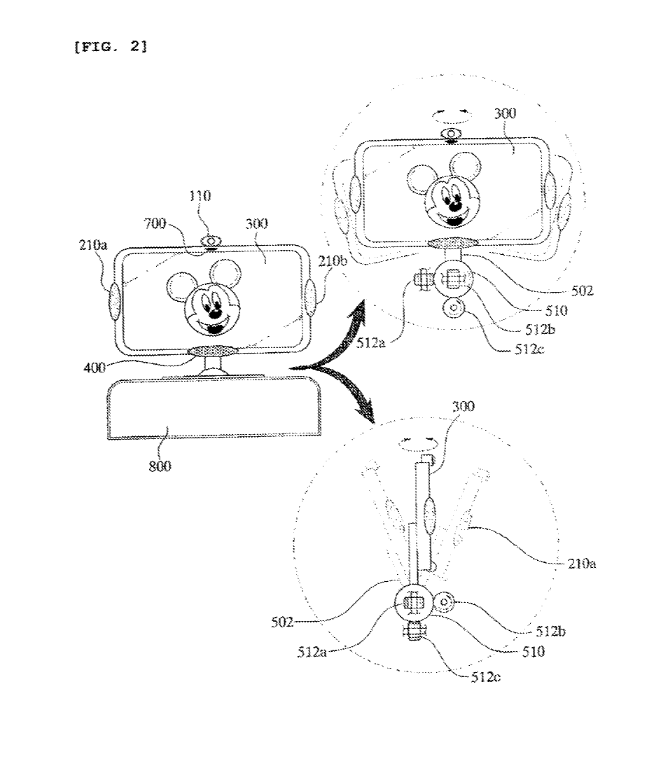

The first driving means 500 is means for gestures through the front and rear or left and right rotational movement and the rotational driving of the first image output means 300 as an aspect of a promotion behavior. The first driving means 500 is driven on the basis of driving information (e.g., a speed and direction necessary for rotational movement or rotation) determined by the control means 600. A detailed construction of the first driving means 500 is described later with reference to FIGS. 2 to 5. In the embodiment of the present invention, a driving method through 3-axis control is used, but simple driving through 1-axis or 2-axis control is also possible.

The second image output means 350 and the second driving means 550 are elements further added to the second embodiment and will be described later with reference to FIG. 5.

FIG. 2 is a front view showing the front of the promotable intelligent display device according to a first embodiment of the present invention and is an operating state diagram schematically showing the driving state of the first driving means subject to 3-axis control. As shown in FIG. 2, the promotable intelligent display device according to the first embodiment of the present invention includes a flat panel display device (e.g., an LCD) as the first image output device 300 on its front side, the camera 110, the microphones 210a and 210b, and the voice output means 400 on its edges, and a first connection shaft 502 and support means 800 under the first image output device 300.

A description of the camera 110, the microphones 210a and 210b, the voice output means 400, and the first image output device 300 described above with reference to FIG. 1 is omitted.

The first driving means 500 described with reference to FIG. 1, as can be seen from the drawing showing the operating state of FIG. 2, includes the first connection shaft 502 configured to transfer motive power to the first image output means 300, a bearing sphere 510 formed at the end of the first connection shaft 502, and one or more rotation motor units 512a, 512b, and 512c configured to adjoin the bearing sphere 510 and transfer rotational power to the bearing sphere 510. Each of the elements is made of abrasion-resistant material (e.g., stainless steel or carbon fiber) so that the element can withstand friction resulting from rotation and rotational movement and may also be made of rubber so that motive power due to frictional force can be transferred.

The operating state schematically shown with some elements omitted in FIG. 2, when viewed from the front, shows that the first image output means 300 is left and right reciprocated and rotatably moved by means of motive power due to the rotation of the third rotation motor unit 512c. Furthermore, the first image output means 300 may also be rotated around the first connection shaft 502 by means of the rotation of the first rotation motor unit 512a.

The operating state schematically shown with some elements omitted in FIG. 2, when viewed from the side, shows that the first image output means 300 is front and rear reciprocated and rotatably moved by means of motive power due to the rotation of the second rotation motor unit 512b. Furthermore, the first image output means 300 may also be rotated around the first connection shaft 502 by means of the rotation of the first rotation motor unit 512a. As a result, as can be seen from the operating state shown in FIG. 2, the first driving means 500 includes the three rotation motor units 512a, 512b, and 512c and enables the front and rear and left and right rotational movement through 3-axis control and the rotational operation around the first connection shaft 502.

A proximity sensor 700 is an element for stopping the driving of the first driving means 500 in order to protect the first image output means 300 or prevent the malfunction of the first image output means 300 by detecting the hand of a user or other objects which approach the first image output means 300. An ultrasonic sensor, an infrared sensor, etc. may be used as the proximity sensor 700. A plurality of the proximity sensors 700 may be used according to the size of the first image output means 300. Furthermore, the infrared sensor having a suitable method may be used because various kinds of the infrared sensors, such as an infrared sensor using reflection and an infrared sensor detecting a change of heat, are commercialized. In addition, a variety of sensors may be used as the proximity sensor 700 of the present invention.

A change in the center of weight may be caused because of the movement of the first image output means 300. The support means 800 is means for solving instability in the first embodiment of the present invention which may be generated by the change, and the support means 800 also plays the role of housing for accommodating the image recognition means 100, the voice recognition means 200, the first driving means 500, and the control means 600. Materials of the support means 800 or a contact area of the support means 800 with the bottom may be appropriately determined by taking the weight of the first image output means 300 into consideration.

<Modification Example of First Driving Means Subject to 3-Axis Control>

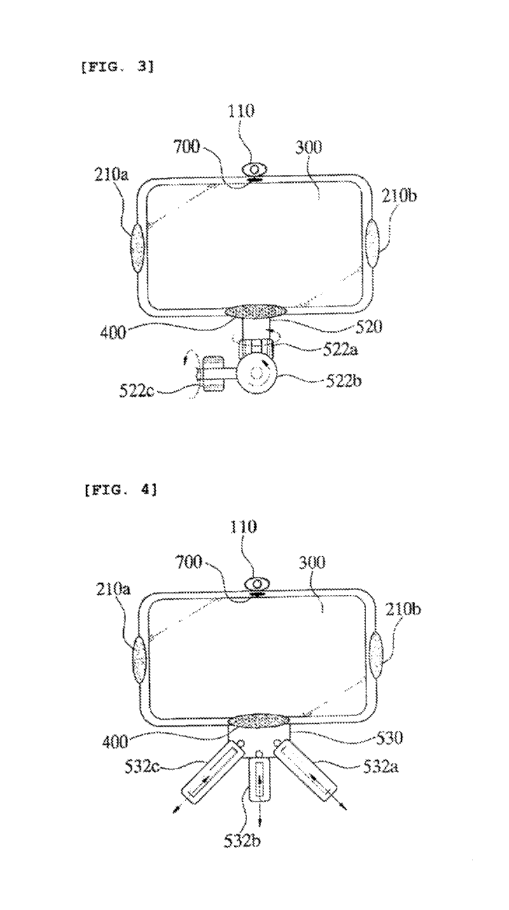

FIG. 3 is a front view showing a first modification example of the first driving means subject to 3-axis control in an embodiment according to the present invention, and FIG. 4 is a front view showing a second modification example of the first driving means subject to 3-axis control in an embodiment according to the present invention. As shown in FIGS. 3 and 4, the first driving means 500 of the present invention is not limited to a specific method, and it may have various modification examples. From among the modification examples, in the first modification example including a first connection shaft 520 and three rotation motor units 522a, 522b, and 522c shown in FIG. 3, the central rotation axis of the first rotation motor unit 522a is directly connected to the first connection shaft 520, thereby enabling the first image output means 300 to be rotatably moved. In this case, a pulley or a gear may be used for inter-shaft coupling. Furthermore, the second rotation motor unit 522b is indirectly and directly connected to the first rotation motor unit 522a and is rotated so that the first image output means 300 is rotatably moved left and right. Furthermore, the third rotation motor unit 522c is indirectly and directly connected to the second rotation motor unit 522b and is rotated so that the first image output means 300 is rotatably moved front and rear.

In the second modification example including a motor coupling unit 530 and three linear driving motor units 532a, 532b, and 532c shown in FIG. 4, the piston linear driving of the first linear driving motor unit 532a and the third linear driving motor unit 532c in opposite directions implements the left and right rotational movement of the first image output means 300. Furthermore, the piston linear driving of the second linear driving motor unit 532b enables the first image output means 300 to be rotatably moved front and rear. Furthermore, rotational movement around the center axis of the motor coupling unit 530 is implemented by controlling an angle at which the first, second, and third linear driving motor units 532a, 532b, and 532c are connected to the motor coupling unit 530 although the rotational movement is incomplete.

### Second Embodiment of Intelligent Display Device

FIG. 5 is a front view showing the front of a promotable intelligent display device according to a second embodiment of the present invention and is a partially enlarged view schematically showing first driving means and second driving means subject to 3-axis control. As shown in FIG. 5, the second embodiment of the intelligent display device is the same as the first embodiment in elements, such as a camera 110, image recognition means 100, microphones 210a and 210b, voice recognition means 200, first image output means 300, voice output means 400, first driving means 500, control means 600, a proximity sensor 700, and a support 800. In the second embodiment, a proximity sensor 750, the second image output means 350, and the second driving means 550 are further added to the first embodiment. Hereinafter, a description of the redundant elements is omitted, and the added elements are described.

The proximity sensor 750 is an element mounted on the edge of the second image output means 350 and configured to protect the second image output means 350 and prevent the malfunction of the second image output means 350. Accordingly, the proximity sensor 750 has the same object as that of the first embodiment of the intelligent display device.

The second image output means 350 is the same as the first image output means 300 except the size and purposes of a screen. In terms of the screen, the first image output means 300 is configured to have a screen size of the degree that the screen can be recognized as the body of a character in order to implement a human-friendly device because the first image output means 300 chiefly output a face image of the character. In terms of the purposes, the first image output means 300 is chiefly used as means for sympathizing with a person, such as outputting a face image of a character and making an expression of a character, whereas the second image output means 350 is used as means for outputting product information and store (or a firm) guidance information in the form of an image.

The second embodiment includes both the first driving means 500 and the second driving means 550. Here, the second driving means 550 includes a second connection shaft 552, a bearing sphere 560, and a plurality of rotation motor units 562a, 562b, and 562c. The second driving means 550 has the same construction as the first driving means 500, including a first connection shaft 572, a bearing sphere 580, and a plurality of rotation motor units 582a, 582b, and 582c. Accordingly, the modification example of the first driving means 500 may also be applied likewise. The first driving means 500 is means for expressing a greeting (e.g., a node), a gesture, etc. of a character which is outputted to the first image output means 300, whereas the second driving means 550 is means for expressing a greeting, a gesture, etc. of a character which are accompanied by the stoop of the waist because the second driving means 550 enables the second image output means 350 to be rotatably moved front and rear and left and right and to be rotatably moved around the second connection shaft 552.

### First Embodiment of Promotion Method

FIG. 6 is a flowchart illustrating a first embodiment of a promotion method according to the present invention. The intelligent display device according to the embodiment of the present invention may be placed in the show window of a store or the entrance, the building lobby, of a building, and it may perform the following promotion method. Referring to FIG. 6, the image recognition means 100 receives an image captured by the camera 110 and recognizes at least one piece of contextual information, from among position information, moving direction information, and distance information of one or more persons, information about the number of persons, and large and small information of the one or more persons, from the received image (S110).

Next, the control means 600 performs a first determination step (S120) of specifying a promotion target at specific time intervals on the basis of the recognized contextual information.

As a first example, a person who is closest through the position information of the one or more persons and also placed within a specific reference distance or less through the distance information of the one or more persons, from among the contextual information, is specified as a promotion target. As a second example, if the number of persons is many (e.g., two or more persons) through the information about the number of persons, a majority of the persons is specified as a first group of promotion targets. If the number of persons is small (e.g., one person), the one person is specified as a promotion target. As a third example, if promotion is for an adult through the large and small information, the adult is specified as a promotion target. If promotion is for a child, the child is specified as a promotion target.

Next, the control means 600 performs a second determination step (S130) of determining driving information of the first image output means 300, such as a speed and direction of rotational movement or rotation, on the basis of position information and moving direction information about the promotion target. At step S130, if the promotion method is applied to the second embodiment of the intelligent display device, driving information of the second image output means 350, such as speed of revolution and a rotation direction, is also determined.

Next, the control means 600 performs a third determination step (S140) of determining a promotion behavior according to distance information of the promotion target, information about the number of persons, and large and small information about the promotion target.

Next, the first driving means 500 connected to the first image output means 300 through a specific first connection shaft 502 rotatably moves or rotates the first image output means 300 through at least one-axis control on the basis of the determined driving information and the determined promotion behavior (S150). At step S150, if the promotion method is applied to the second embodiment of the intelligent display device, the second driving means 550 also rotatably moves or rotates the second image output means 350.

Next, the first image output means 300 performs an image output step (S160) of outputting a character image or a promotion image on the basis of the promotion behavior. At step S160, if the promotion method is applied to the second embodiment of the intelligent display device, not only the first image output means 300, but also the second image output means 350 outputs an image.

Next, the voice output means 400 performs a voice output step (S170) of outputting character voice or promotion voice on the basis of the promotion behavior.

For example, an expression (e.g., a gesture or a voice expression, such as ‘everybody’, through a motion of the first image output means 300 or an outputted character’), indicating that the number of persons is recognized based on the information about the number of persons, may be made. Furthermore, in case of an adult or a child, an image of a relevant character may be outputted. Furthermore, the size of an image outputted through the first image output means 300 or the volume of voice outputted through the voice output means 400 may be controlled based on the distance information.

### Second Embodiment of Promotion Method

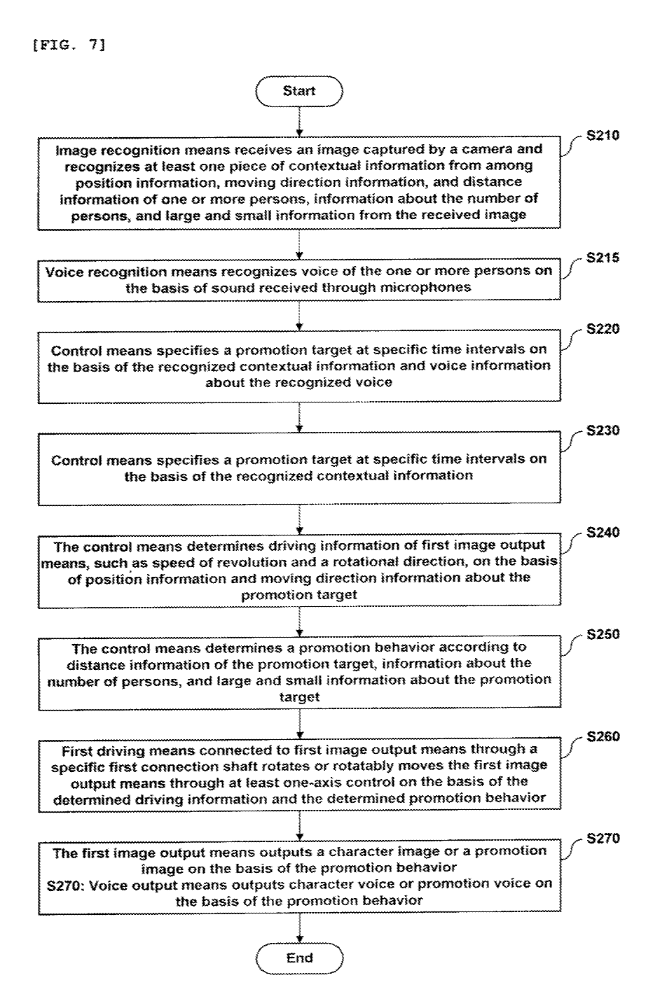

FIG. 7 is a flowchart illustrating a second embodiment of a promotion method according to the present invention. Referring to FIG. 7, first, the image recognition means 100 performs an image recognition step (S210) of receiving an image captured by the camera 110 and recognizing at least one piece of contextual information, from among position information, moving direction information, and distance information of one or more persons, information about the number of persons, and large and small information of the one or more persons, from the received image.

Next, the voice recognition means 200 performs a voice recognition step (S215) of recognizing voice of the one or more persons on the basis of sound received through the microphones 210a and 210b.

Next, the control means 600 performs a first determination step (S220) of specifying a promotion target at specific time intervals on the basis of the recognized contextual information and voice information about the recognized voice. That is, the control means 600 determines the promotion target by comparing the recognized image with the recognized voice. The contextual information given as an image has the first priority, and the voice information functions to supplement the determination.

Next, the control means 600 performs a second determination step (S230) of determining driving information of the first image output means 300, such as speed of revolution and a rotation direction, on the basis of position information and moving direction information about the promotion target.

Next, the control means 600 performs a third determination step (S240) of determining a promotion behavior according to distance information of the promotion target, information about the number of persons, and large and small information about the promotion target.

Next, the first driving means 500 connected to the first image output means 300 through a specific first connection shaft 502 rotatably moves or rotates the first image output means 300 through at least one-axis control on the basis of the determined driving information and the determined promotion behavior (S250).

Next, the first image output means 300 performs an image output step (S260) of outputting a character image or a promotion image on the basis of the promotion behavior.

Next, the voice output means 400 performs a voice output step (S270) of outputting character voice or promotion voice on the basis of the promotion behavior.

1. A promotable intelligent display device comprising:
first image output means for outputting a character image of a specific character and a promotion image for specific promotion;
a camera placed on one side of the first image output means, for capturing an image of one or more persons;
image recognition means for receiving the captured image of the camera and outputting at least one piece of contextual information, from among position information, moving direction information, and distance information of the one or more persons, information about the number of persons, and Size information of the one or more persons;
control means for specifying a promotion target at specific time intervals on the basis of the recognized contextual information of the image recognition means, determining driving information regarding a speed and direction of rotational movement or rotation of the first image output means on the basis of position information and moving direction information about the specified promotion target, and determining a promotion behavior according to distance information of the promotion target, information about the number of persons, and Size information of the promotion target;
voice output means for outputting character voice of the character and the promotion voice for promotion on the basis of the promotion behavior determined by the control means; and
first driving means connected to the first image output means through a specific first connection shaft, for enabling the first image output means to be rotatably moved or rotated through at least one-axis control on the basis of the determined driving information and the determined promotion behavior.

2. The promotable intelligent display device according to claim 1, wherein the promotion image is product information or store guidance information.

3. The promotable intelligent display device according to claim 1, wherein:
the camera comprises two or more cameras spaced apart from each other, and
the image recognition means obtains the distance information as a relative position contrasted with a background image, of an identical person who is photographed by the two or more cameras at an identical time.

4. The promotable intelligent display device according to claim 3, wherein the distance information is distance information from the first image output means to the one or more persons.

5. The promotable intelligent display device according to claim 1, wherein the specified promotion target is a person having a least change in the position from among the one or more persons.

6. The promotable intelligent display device according to claim 1, wherein the promotion behavior includes at least one of the promotion image, the promotion voice, a motion of the first image output means, and a change of the character image.

7. The promotable intelligent display device according to claim 1, wherein the first driving means comprises one or more rotation motor units consecutively connected to an end of the first connection shaft, formed in a backside of the first image output means, in a length direction.

8. The promotable intelligent display device according to claim 7, wherein:
the first connection shaft further comprises a bearing sphere formed at an end of the length direction, and
the one or more rotation motor units are adjoined to the bearing sphere and are rotated.

9. The promotable intelligent display device according to claim 1, wherein the first driving means comprises:
a motor coupling unit further formed in the first connection shaft, and
one or more linear driving motor units connected to the motor coupling unit.

10. The promotable intelligent display device according to claim 1, further comprising:
microphones for receiving sound information, and
voice recognition means for recognizing voice of the one or more persons on the basis of the sound information received through the microphones,
wherein the control means specifies the promotion target on the basis of voice information of the recognized voice along with the recognized contextual information.

11. The promotable intelligent display device according to claim 1, wherein:
the first driving means is placed under the first image output means,
the promotable intelligent display device further comprises second image output means under the first driving means and second driving means connected to the second connection shaft formed in a backside of the second image output means, thus enabling the second image output means to he rotated and rotatably moved.

12. The promotable intelligent display device according to claim 11, wherein the second image output means is a touch screen for receiving a touch input of a specific user.

13. The promotable intelligent display device according to claim 11, further comprising one or more proximity sensors for preventing the first driving means and the second driving means from being driven by outputting a detection signal to the control means, if the promotion target or a specific object approaches the first image output means and the second image output means within a specific area.

14. A promotion method of an intelligent display device, comprising:
an image recognition step in which image recognition means receives an image captured by a camera and recognizes at least one piece of contextual information, from among position information, moving direction information, and distance information of one or more persons, information about the number of persons, and Size information of the one or more persons, from the received image;
a first determination step in which control means specifies a promotion target at specific time intervals on the basis of the recognized contextual information;
a second determination step in which the control means determines driving information of first image output means, such as a speed and direction of rotational movement or rotation, on the basis of position information and moving direction information about the promotion target;
a third determination step in which the control means determines a promotion behavior according to distance information of the promotion target, information about the number of persons, and Size information about the promotion target;
a step in which first driving means connected to the first image output means through a specific first connection shaft rotatably moves or rotates the first image output means through at least one-axis control on the basis of the determined driving information and the determined promotion behavior;
an image output step in which the first image output means outputs a character image or a promotion image on the basis of the promotion behavior; and
a voice output step in which voice output means outputs character voice or promotion voice on the basis of the promotion behavior.

15. A promotion method of an intelligent display device, comprising:
an image recognition step in which image recognition means receives an image captured by a camera and recognizes at least one piece of contextual information, from among position information, moving direction information, and distance information of one or more persons, information about the number of persons, and Size information of the one or more persons, from the received image;
a voice recognition step in which voice recognition means recognizes voice of the one or more persons on the basis of sound received through microphones;
a first determination step in which control means specifies a promotion target at specific time intervals on the basis of the recognized contextual information and voice information of the recognized voice;
a second determination step in which the control means determines driving information of first image output means, such as speed of revolution and a rotation direction, on the basis of position information and moving direction information about the promotion target;
a third determination step in which the control means determines a promotion behavior according to distance information of the promotion target, information about the number of persons, and Size information about the promotion target;
a step in which first driving means connected to the first image output means through a specific first connection shaft rotatably moves or rotates the first image output means through at least one-axis control on the basis of the determined driving information and the determined promotion behavior;
an image output step in which the first image output means outputs a character image or a promotion image on the basis of the promotion behavior; and
a voice output step in which voice output means outputs character voice or promotion voice on the basis of the promotion behavior.
